(19) United States
(12) Patent Application Publication
(10) Pub. No.: US 2021/0234280 A1
(43) Pub. Date: Jul. 29, 2021

(54) ANTENNA

(71) Applicant: Nokia Shanghai Bell Co., Ltd., Shanghai (CN)

(72) Inventors: Mohammad Reza DEHGHANI KODNO, Trignac (FR); Yoann LETESTU, Trignac (FR)

(73) Assignee: Nokia Shanghai Bell Co., Ltd., Shanghai (CN)

(21) Appl. No.: 17/262,797

(22) PCT Filed: Aug. 8, 2018
(86) PCT No.: PCT/IB2018/055987

§ 371 Date: Jan. 25, 2021

(51) Int. Cl. H01Q 19/06; H01Q 1/42; H01Q 19/18

(52) U.S. Cl. CPC H01Q 19/065; H01Q 19/18; H01Q 1/42

(57) ABSTRACT

A folded lens antenna structure comprising: a stack comprising in order: a reflector; a dielectric gap; and a sub-reflector plate of smaller area than the reflector.

### TECHNOLOGICAL FIELD

Embodiments of the present disclosure relate to antennas and components for antennas.

### BACKGROUND

Point-to-point radio communication may use a parabolic reflector to create a focused beam of electromagnetic radiation. It is well understood that if a source of electromagnetic radiation is placed at a focal point of the parabolic reflector, then the parabolic reflector will create a beam of parallel rays of electromagnetic radiation.

Such an antenna can provide a high bandwidth as it can be operated simultaneously over many different frequency bands. Such an antenna can also operate with any polarization of electromagnetic radiation. However, it is bulky because of the distance of the focal point from the parabolic reflector and the size of the parabolic reflector.

It would be desirable to produce an antenna that is less bulky and operates over multiple frequency bands simultaneously and dual-polarization simultaneously.

### BRIEF SUMMARY

According to various, but not necessarily all, embodiments there is provided a folded lens antenna structure comprising: a stack comprising in order: a reflector; a dielectric gap; and a sub-reflector plate of smaller area than the reflector.

In at least some examples, the sub-reflector plate is flat.

In at least some examples, the sub-reflector plate is curved. In at least some examples, the sub-reflector plate has a concave curvature facing the reflector. In at least some examples, the sub-reflector plate has a convex curvature facing the reflector.

In at least some examples, the sub-reflector plate comprises conducting material.

In at least some examples, the sub-reflector plate is metallic.

In at least some examples, the folded lens antenna structure comprises a lens adjacent the sub-reflector plate.

In at least some examples, the lens has a focal point outside the lens and a focal length of approximately three times a height of the stack.

In at least some examples, the sub-reflector plate is convex, forming a Cassegrain configuration.

In at least some examples, the sub-reflector plate is concave, forming a Gregorian configuration.

In at least some examples, the sub-reflector plate is an integral part of the lens. In at least some examples, the sub-reflector plate is printed on the lens.

In at least some examples, the lens is provided by a radome,

According to various, but not necessarily all, embodiments there is provided examples as claimed in the appended claims.

### BRIEF DESCRIPTION

Some example embodiments will now be described with reference to the accompanying drawings in which:

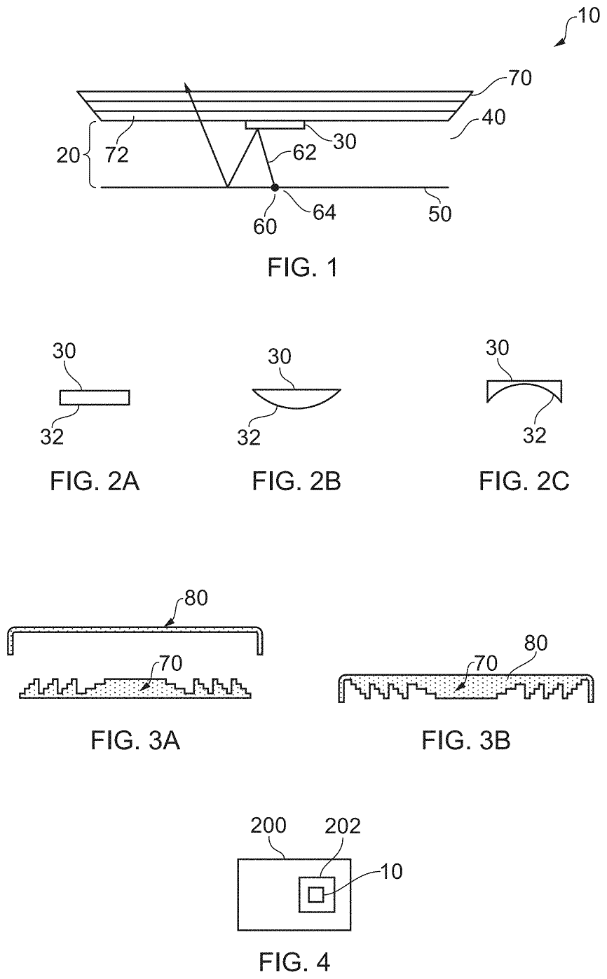

FIG. 1 shows an example embodiment of the subject matter described herein;

FIG. 2A, 2B, 20 each show another example embodiment of the subject matter described herein;

FIG. 3A, 3B each show another example embodiment of the subject matter described herein;

FIG. 4 shows another example embodiment of the subject matter described herein.

### DETAILED DESCRIPTION

FIG. 1 illustrates an example of a folded lens antenna structure 10. The folded lens antenna structure 10 comprises a stack 20 comprising in order: a reflector 50, a dielectric gap 40 and a sub-reflector plate 30.

The sub-reflector plate 30 is of smaller area than the reflector 50. The sub-reflector plate 30 will create a shadow. It is therefore preferred to make it small.

The dielectric gap 40 may be an air gap or may comprise other dielectric material.

The structure 10 is folded in that electromagnetic radiation 62 takes a zig-zag path through the stack 20 before it emerges from the stack 20. The electromagnetic radiation 62 that emerges from the stack 20 has been reflected by the sub-reflector plate 30 and also by the reflector 50. The path length for the electromagnetic radiation 62 through the stack 20 is therefore significantly greater than the thickness of the stack 20 because of the two reflections. This means that a lens 70 may be placed adjacent the stack 20 that has a focal length F significantly greater than the height H of the stack 20 but substantially equal to the zig-zag path length L of the electromagnetic radiation 62 through the stack 20, where F=L≈3H. The folded lens antenna structure 10 is therefore a compact arrangement that enables the use of a lens 70 that has a focal length greater than the height of the stack 20. The lens 70 can for example be a lens with a focal length of approximately three times the height of the stack 20. The sub-reflector plate 30 is configured reflect electromagnetic radiation 62. The sub-reflector plate 30 is formed from a continuous layer of conductive material. The conductive material may, for example, be metallic.

As illustrated in FIG. 2A, in some examples, the sub-reflector plate 30 has a surface 32 that faces the reflector 50 that is a flat rectilinear plane.

Alternatively, as illustrated in FIG. 2B and 2C, in some examples, the sub-reflector plate 30 has a surface 32 that faces the reflector 50 that is curved.

In the example illustrated in FIG. 2B, the surface 32 has a concave curvature facing the reflector 50.

In the example illustrated in FIG. 20, the surface 32 has a convex curvature facing the reflector 50.

The reflector 50 is configured to reflect electromagnetic radiation 62. The reflector 50 is formed from a continuous layer of conductive material. The conductive material may, for example, be metal.

The reflector 50 may be a flat rectilinear plane or may be curved. For example, the sub-reflector plate 30 may have a convex curvature facing the lens 70.

The folded lens antenna structure 10 may comprise, within the reflector 50 an aperture 64 for receiving electromagnetic radiation 62 from a source 60. The source 60 can be a waveguide feed or printed radiating element such as Aperture Coupled Microstrip Patch antennas. The source 60 can be dual-polarization and/or multi-frequency.

The bandwidth of the electromagnetic radiation 62 provided by the waveguide feed 60 has a large bandwidth that covers at least some or all of a first frequency band F1 and some or all of the second frequency band F2 separated from the first frequency band F1.

The electromagnetic radiation 62 provided by the source 64 is reflected by the sub-reflector plate 30 towards the reflector 50. The reflected electromagnetic radiation 62 is reflected by the reflector 50 towards the lens 70.

The lens 70 may be any suitable type of lens. Suitable lenses have a focal point outside the lens, and examples include but are not limited to: Fresnel zone plate lenses, hemispherical lenses, printed discrete lenses (transmit-arrays), graded index lenses, sub wavelength structured lenses, hemispherical lenses and hyperbolic lenses etc. For example, the lens may be a Fresnel lens, such as a folded Fresnel lens or Fresnel zone plate lens.

In some but not necessarily all examples, the sub-reflector plate 30 has a concave curvature facing the reflector 50. The combination of the sub-reflector plate 30, reflector 50 and lens 70 creates a Cassegrain configuration, where the sub-reflector plate 30 operates as a convex Cassegrain secondary reflector and the reflector 50 and lens 70 are configured simulate a concave, parabolic, Cassegrain primary reflector,

The lens 70 is then designed to operate as an appropriate phase correcting aperture.

In some but not necessarily all examples, the sub-reflector plate 30 has a convex curvature facing the reflector 50. The combination of the sub-reflector plate 30, reflector 50 and lens 70 creates a Gregorian configuration, where the sub-reflector plate 30 operates as a concave Gregorian secondary reflector and the reflector 50 and lens 70 are configured to simulate a concave, parabolic, Gregorian primary reflector. The lens 70 is then designed to operate as an appropriate phase correcting aperture,

The sub-reflector plate 30 may be formed on a lower surface of the lens 70 such that it is an integrated part of the lens 70.

In some but not necessarily all examples, the sub-reflector plate 30 is printed onto the lower surface 72 of the lens 70 such that it is an integrated part of the lens 70.

The lens 70 may in some examples be a Fresnel zone plate lens, for example as illustrated in FIG. 3A, In this example, a separate radome 80 is used as a protective cover for the lens 70.

In other examples, the lens 70 may be an inversed Fresnel zone plate lens, for example as illustrated in FIG. 3B. The term ‘inversed’ means upside down. In this example but not necessarily all examples, the inversed Fresnel zone plate lens 70 is formed as an integral part of a radome cover 80, The lens 70 acts as the external protective cover 80.

FIG. 4 illustrates an example of a base station 200 for a cell of cellular communication system. The base station 200 comprises a backhaul radio frequency transceiver system 202 comprising the multi-frequency folded lens antenna structure 10 for point-to-point communication, The radio frequency transceiver system 202 is configured, in this example, to operate at frequencies in excess of 20 GHz with dual polarization. It operates at high gain (>30 dBi) and has a large bandwidth (20%).

Where a structural feature has been described, it may be replaced by means for performing one or more of the functions of the structural feature whether that function or those functions are explicitly or implicitly described.

The term ‘comprise’ is used in this document with an inclusive not an exclusive meaning. That is any reference to X comprising Y indicates that X may comprise only one Y or may comprise more than one Y. if it is intended to use ‘comprise’ with an exclusive meaning then it will be made clear in the context by referring to “comprising only one” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class, It is therefore implicitly disclosed that a feature described with reference to one example but not with reference to another example, can where possible be used in that other example as part of a working combination but does not necessarily have to be used in that other example.

Although embodiments have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain embodiments, those features may also be present in other embodiments whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer and exclusive meaning.

The presence of a feature (or combination of features) in a claim is a reference to that feature) or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The use of the term ‘example’ or ‘for example’or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/we claim:

1. A folded lens antenna structure comprising:
a stack comprising in order,:
a reflector; a dielectric gap; and a sub-reflector plate of smaller area than the reflector.

2. A folded lens antenna structure as claimed in claim 1, wherein the sub-reflector plate is flat.

3. A folded lens antenna structure as claimed in claim 1, wherein the sub-reflector plate is curved.

4. A folded lens antenna structure as claimed in claim 3, wherein the sub-reflector plate has a concave curvature facing the reflector.

5. A folded lens antenna structure as claimed in claim 3, wherein the sub-reflector plate has a convex curvature facing the reflector.

6. A folded lens antenna structure as claimed in claim 1, wherein the sub-reflector plate comprises conducting material.

7. A folded lens antenna structure as claimed in claim 1, wherein the sub-reflector plate is metallic.

8. A folded lens antenna structure as claimed in claim 1, further comprising:
a lens adjacent the sub-reflector plate.

9. A folded lens antenna structure as claimed in claim 8, wherein the lens has a focal point outside the lens and a focal length of approximately three times a height of the stack.

10. A folded lens antenna structure as claimed in claim 8, wherein the sub-reflector plate is convex, forming a Cassegrain configuration.

11. A folded lens antenna structure as claimed in claim 8, wherein the sub-reflector plate is concave, forming a Gregorian configuration.

12. A folded lens antenna structure as claimed in claim 8, wherein the sub-reflector plate is an integral part of the lens.

13. A folded lens antenna structure as claimed in claim 12, wherein the sub-reflector plate is printed on the lens.

14. A folded lens antenna structure as claimed in claim 9, wherein the lens is provided by a radome.

15. A radome providing an inverse Fresnel zone plate lens for a folded lens antenna structure.
